(19) United States
(12) Patent Application Publication
(10) Pub. No.: US 2010/0160707 A1
(43) Pub. Date: Jun. 24, 2010

(54) Encapsulation of Waste for Storage

(76) Inventor: Douglas Kirk, Cheshire (GB)

Correspondence Address: THE SMALL PATENT LAW GROUP LLP, 225 S. MERAMEC, STE. 725T, ST. LOUIS, MO, 63105, US

(21) Appl. No.: 12/083,526

(22) PCT Filed: Oct. 23, 2007
(86) PCT No.: PCT/EP2007/009195

§ 371 Date: Nov. 17, 2008

Related U.S. Application Data
(60) Provisional application No. 60/863,037, filed on Oct. 26, 2006.

(51) Int. Cl. G21F 9/00; G21F 9/16; C02F 11/12; G21F 9/28; B01J 19/00

(52) U.S. Cl. 588/4; 422/159; 422/187; 588/3; 588/255; 588/2

(57) ABSTRACT

An apparatus for encapsulating waste material (e.g radioactive sludge from nuclear processing plant) in a container (e.g Nirex box) for long term storage, comprising: a first storage vessel, for holding sludge; a second storage vessel, for holding encapsulation medium (e.g. cement based grout); an inline mixer (e.g. a static inline mixer), coupled for receiving sludge, and coupled to the second storage vessel, and producing, in use, a mixture of the sludge and grout; wherein the inline mixer is arranged for filling the container. Preferably, a dewatering unit (e.g. HydroTrans based), coupled for receiving sludge and outputting dewatered sludge to be mixed by the inline mixer. An encapsulation system comprising the encapsulation apparatus, and corresponding encapsulation methods, are also disclosed.

### CROSS REFERENCE TO RELATED APPLICATIONS

This application is a filing under 35 U.S.C. §371, which claims priority to PCT Application PCT/EP2007/009195, filed Oct. 23, 2007, and U.S. Provisional Patent Application No. 60/863,037, filed Oct. 26, 2006, which are each hereby incorporated by reference in their entirety.

### BACKGROUND OF THE INVENTION

The present invention relates to the conditioning of Intermediate and Low Level Radioactive Waste materials, and more particularly to apparatus, methods and systems for encapsulation of waste materials for long term storage.

It is well known that certain waste by products of industrial processes, especially radioactive waste materials generated by nuclear processing plants, and other hazardous waste material, need to be safely and securely disposed of, typically by encapsulation techniques within containers, in a way that is suited to long term storage (e.g. in a robust containment, until the radioactivity has decayed to non-hazardous levels).

More recently, an example of such storage involves mixing the radioactive hazardous waste—typically in the form of wet sludge with dry encapsulation powders, such as cement—in a container such as a metal drum having an integral mixing paddle. The mixture is allowed to cure in the drum. The purpose of this is to encapsulate the (radioactive) waste in an (eventually) solid material within the drum; the drums can then be disposed in a suitable storage location, such as an underground storage site.

A problem with known systems is that an internal paddle is used within the drum for mixing. In the case where the paddle is re-used, cleaning of the paddle is required, which is a time consuming process and generates radioactive secondary waste. In the case where the paddle is left in the drum and disposed of therewith, extra parts (paddles) are required for each drum.

A further problem is that through the use of moving paddles within the drum, the preloading of the drum with additional solid articles of waste (e.g., metal items and fuel element debris, etc.), prior to adding the sludge waste and the dry grout powders, is prevented, as the solids would block/hinder the paddles' movement and hence prevents the incorporation of solid waste in the same drum thus reducing the overall amount of waste stored in the drum, per unit volume.

A further problem is that, with the use of such drums, the amount of stored volume of waste is not optimized in relation to the volume utilisation in the store.

### BRIEF DESCRIPTION OF THE INVENTION

Various embodiments of the present invention seek to address the aforementioned and other issues, and provide improved techniques for the encapsulation of waste for long term storage by a process that is insensitive to the geometry of the long term storage container.

According to one aspect of the present invention there is provided apparatus for encapsulating waste material in a container for long term storage, comprising: a first storage vessel, for holding waste material; a second storage vessel, for holding encapsulation medium; a static vane in-line mixer, coupled for receiving waste material, and coupled to the second storage vessel, and producing, in use, a mixture of the waste material and encapsulation medium; wherein the in-line mixer is arranged for filling the container and wherein the in-line mixer comprises a disposable component located inside the container mounted on an internal surface of the container.

The apparatus may further include a dewatering unit (108), coupled for receiving waste material from the first vessel (106) and outputting dewatered waste material; wherein the inline mixer (112) is coupled to the dewatering unit and to the second storage vessel (114), for receiving material therefrom and producing a mixture of the dewatered waste material and encapsulation medium. Preferably, the dewatering unit includes a dewatering vessel and a pump for providing a degree of vacuum in the dewatering vessel. Preferably, the dewatering unit is operable for concentrating the waste material such that the dewatered waste material output is at about 40% v/v.

In one embodiment, the container comprises a main body and a separate lid member; the lid member being adapted for fixed attachment to the main body of the container, and inline mixer is provided in or on a lid member; such that when the lid member is fixedly attached to the main body of the container, the inline mixer is enclosed within the container.

In another embodiment, the container comprises unitary component with a main body and an integrally formed or fixedly attached lid member.

The inline mixer may comprise a static inline mixer, for example provided with fixed internal vanes.

The apparatus further may include a first pump disposed between the first vessel and the dewatering unit and/or a second pump disposed between the second vessel and the inline mixer. The apparatus further may include a valve upstream of each of two inlet ports of the inline mixer.

The waste material may comprise sludge, liquid or semi solid material.

In one embodiment, the waste material comprises radioactive sludge from nuclear processing plant, and the encapsulation medium comprises grout. Preferably, the encapsulation medium is a cement-based grout, for example comprising a mixture of BFS and OPC or PFA and OPC.

In another embodiment, the waste material comprises VOC5, and the encapsulation medium comprises polymer compound.

According to another aspect of the present invention there is provided a system for encapsulating waste material for long term storage, comprising: the apparatus of any of claims 1 to 14 of the appended claims; and a container, the container comprising (i) a main body and separate lid member, or (ii) a unitary component with a main body and an integrally formed or fixedly attached lid member. The container may contain solid hazardous waste,

According to another aspect of the present invention there is provided a container for use in conjunction with the apparatus of any of claims 1 to 14 of the appended claims, or in the system of claim 15 or 16 of the appended claims; the container comprising: (i) a main body and separate lid member, or (ii) a unitary component with a main body and an integrally formed or fixedly attached lid member; wherein the inline mixer is disposed inside the container or on mounted an internal surface of the container, for example on an inner surface of the lid member.

According to another aspect of the present invention there is provided a method of encapsulating waste material in a container for long term storage, comprising: (a) providing a first storage vessel, for holding waste material; (b) providing a second storage vessel, for holding encapsulation medium; (c) providing a static vane inline mixer, coupled for receiving waste material, and coupled to the second storage vessel, (f) mixing the waste material and encapsulation medium in the inline mixer; (g) filling the container with the mixture output from the inline mixer, wherein (c) includes providing a container, wherein the inline mixer comprises a disposable component disposed inside the container or on mounted an internal surface of the container.

The method may further include: (d) providing a dewatering unit, coupled to the first vessel, and (e) dewatering the waste material received from the first vessel and outputting dewatered waste material; wherein the inline mixer is coupled to the dewatering unit and to the second storage vessel, (f) comprises producing a mixture of the dewatered waste material and encapsulation medium. Preferably, the dewatering unit includes a dewatering vessel and (e) includes using a pump to provide a degree of vacuum in the dewatering vessel. Preferably, (e) includes concentrating the waste material such that the dewatered waste material output is at about 40% v/v.

In one embodiment, the container comprises a main body and a separate lid member; and (c) includes fixedly attaching the lid member to the main body of the container, and wherein inline mixer is provided in or on a lid member; such that when the lid member is fixedly attached to the main body of the container, the inline mixer is enclosed within the container.

In another embodiment, the container comprises unitary component with a main body and an integrally formed or fixedly attached lid member. Preferably, the inline mixer comprises a static inline mixer, for example provided with internal vanes.

The method may further include: (h) pumping with a first pump the material output from the first vessel to the dewatering unit; and/or (i) pumping with a second pump the material output from the second vessel to the inline mixer.

The method may further include: (j) controlling the flow of material to the inline mixer using a valve upstream of each of two inlet ports of the inline mixer.

The waste material may comprise sludge, liquid or semi solid material.

In one embodiment, the waste material comprises radioactive sludge from nuclear processing plant, and the encapsulation medium comprises grout. Preferably, the encapsulation medium is a cement-based grout, for example comprising a mixture of BFS and OPC or PEA and OPC.

In another embodiment, the waste material comprises VOCs, and the encapsulation medium comprises polymer compound.

The method may further include preloading the container with solid hazardous waste.

A versatile encapsulation plant is provided for use in the encapsulation of waste, particularly that arising in the Nuclear Industry. The design allows within a single process plant the capacity to condition both solid waste materials and sludge wastes (individually or in combination) into an encapsulated product form suitable for safe, long-term storage.

The process provides the equipment necessary to receive sludge wastes streams; dewater the sludge to remove excess water and concentrate the sludge; receive a pre-mixed wet encapsulation medium, or grout: transfer the dewatered sludge and grout into a static in-line mixer; depositing the ‘mixed’ sludge/grout stream into a waste container, drum or box suitable for long term storage.

The storage container, drum or box could also have been previously ‘loaded’ with solid wastes, thus allowing the encapsulation of these solid wastes using the sludge/grout mixed material.

Once the mixed sludge/encapsulation medium has been transferred into the storage container, drum or box, it is left undisturbed for a number of hours to allow ‘curing’. This results in a container, drum or box containing a single solid mass of encapsulated waste suitable for storage.

The system may employ a standard cuboid storage box, giving

(i) a 25% volume utilisation increase for sludge waste compared to a ‘large drum’ lost paddle in-drum mixing system occupying the same floor area, and

(ii) a 60% increase compared with a drum stillage containing 4 in-drum mixed drums occupying the same floor area.

The design is capable of filling drums and boxes in a range of sizes.

It has been found that circa 25% w/w sludge solids incorporation can be achieved for sludge type waste streams, compared with c. 15% w/w typical with in-drum mixing technology. These two aspects result in a dramatic reduction (greater than 50%) in the number of boxes containing conditioned sludge waste required to be stored, with the consequent large savings in lifetime costs.

### BRIEF DESCRIPTION OF THE DRAWINGS

Embodiments of the invention will now be described in detail, by way of example, with reference to the accompanying drawings, in which:

FIG. 1 shows schematically a hazardous waste encapsulation system according to an embodiment of the invention:

FIG. 2 shows in more detail (a) the main body of the container, and (b) the underside of the lid or of the topside of the container, in the encapsulation system of FIG. 1; and

FIG. 3 depicts part of the encapsulation system of FIG. 1 in more detail, showing the connection of the dewatering system.

In the description and drawings, like numerals are used to designate like elements. Unless indicated otherwise, any individual design features and components may be used in combination with any other design features and components disclosed herein.

### DETAILED DESCRIPTION OF THE INVENTION

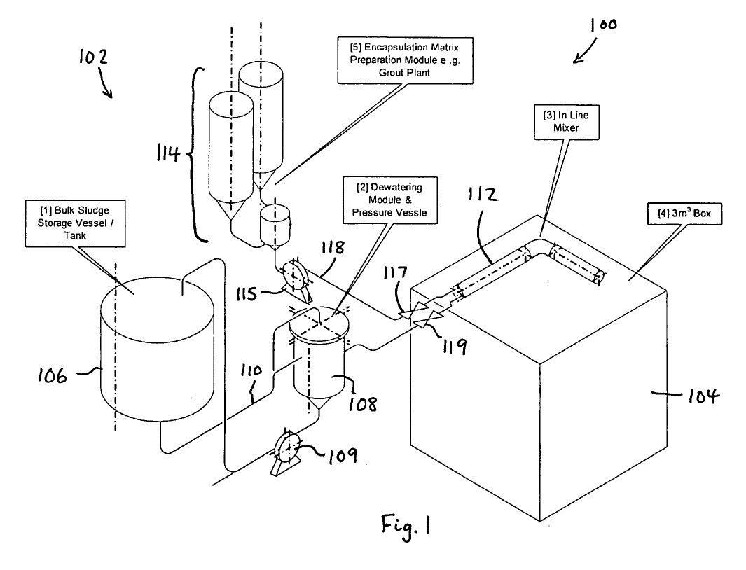

FIG. 1 shows schematically a hazardous waste encapsulation system according to an embodiment of the invention.

For solid waste streams, the encapsulation medium, or grout, is prepared in an adjacent mixing plant and pumped directly to the encapsulation container or box 104.

For sludge waste streams (as in the embodiment of FIG. 1), the encapsulation apparatus 102 according to the invention, in preferred embodiments, makes use of a dewatering unit 108 for conditioning the sludge waste feed, and an in-line static mixer 112 to mix the sludge with a pre-mixed encapsulation medium or ‘grout’. The dewatering unit 108 removes excess water from the sludge and is provided to allow the flexibility to receive a wide range of sludge type streams.

The sludge is transferred from a transit storage vessel 106 into the dewatering unit 108 via sludge waste feed 110. The dewatering unit suitably includes a pump 109, for providing a degree of vacuum within the container vessel of the dewatering unit 108.

Returning again to FIG. 1, a wet encapsulation medium prepared in an adjacent mixing plant 114 is then fed into the other input of the static in-line mixer 112. Whilst the most frequent medium to be employed is cement based grout, using combinations of Blast Furnace Slag (BFS) and Ordinary Portland Cement (OPC), the various embodiments of the invention may also be used to encapsulate using other encapsulation media such as polymer compounds. The latter allows the potential to encapsulate sludges containing organics, i.e. VOCs etc.

Both the conditioned sludge feed 110 and encapsulation medium feed 118 are fed simultaneously into the static in-line mixer 112. Flow control systems are employed to ensure strict matching of the two flow rates to maintain the correct sludge to encapsulation medium ratio.

The process allows the maximum utilisation of a cuboid box volume (25% greater than the large in-drum mixing container and 60% greater than a drum stillage containing 4 in-drum mixed drums configuration) and an increased incorporation rate (−25 wt %) of the sludge solids in grout.

As there are no moving parts within the box 104, the sludge bearing encapsulation medium can be used to encapsulate solid waste pre-loaded into the box 104.

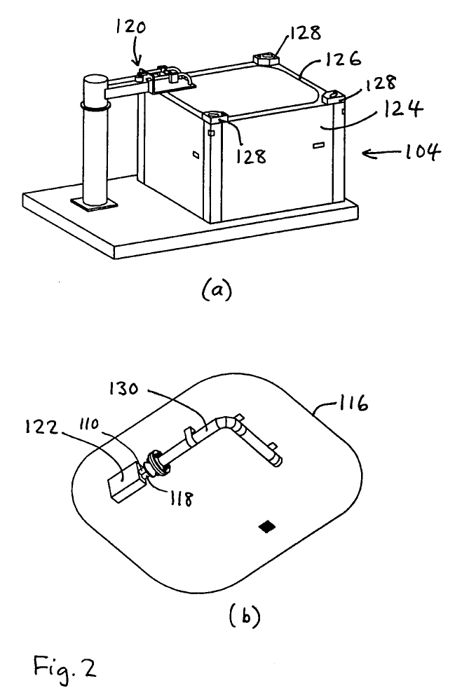

FIG. 2 shows in more detail (a) the main body of the container 104, and (b) the underside of the lid or of the topside of the container, in the encapsulation system of FIG. 1.

The in-line mixer 112 may be located, as in the example shown here, inside the lid 116 of a NIREX 3 m³ Box 104. As seen in FIG. 2(a), a valve arrangement, generally designated 120, receives the feeds 110 and 118 (see FIG. 1; with one valve being provided for each feed line) and couples to an input port 122 of the inline mixer 112.

The main body 124 of the box 104 is generally cuboid with and upper edge 126 on which are provided guide/retention members 128 at each corner. The guide/retention members 128 assist in receiving and retaining the lid 116. It will be appreciated by persons skilled in the art that while the box 104 may be fabricated, delivered and/or used in the form of separate main body 124 and lid 116, it is also possible that the box 104 is fabricated/provided as an integral container, with the inline mixer mounted on the underside of the topside of the box.

Referring in particular to FIG. 2(b), a static in-line mixer 112 is used to mix the sludge and encapsulation medium upon transfer to the box 104. The in-line mixer 112 is for example a Chemineer Kenics Static KMS In-line mixer.

The in-line mixer 112 consists of a tube 130 and has no moving parts or components. The in-line mixer 112 is fed from two pipes, one (110) feeding the sludge, and one (118) feeding the wet encapsulation medium.

As the sludge and encapsulation medium pass through the tube 130 of the mixer, fixed elements or plates (not shown) inside the in-line mixer 112 cause the two streams to mix together, forming a homogenous stream of combined sludge and encapsulation medium. The resultant homogenous material then falls into the box 104. The box is filled to a predetermined level and left for a set period of time for curing. The combined sludge/encapsulation medium then hardens to form a solid mass within the box 104.

As will be appreciated by persons skilled in the art, the diameter, length and number of elements within the in-line mixer can all be changed to give the process the versatility to encapsulate differing waste streams. These parameters may be controlled and set following initial ‘proving trials’.

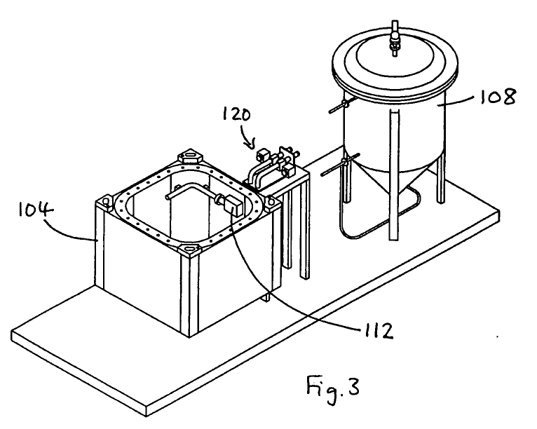

FIG. 3 depicts part of the encapsulation system of FIG. 1 in more detail, showing the connection of the dewatering unit 108. The dewatering unit 108 removes excess water from the sludge, employing for example ‘HydroTrans’ technology (see UK patent applications Nos GB2389094A and GB2406293A), using fluid to mobilise and transport solids, thus removing supernate from the sludge and concentrating the sludge up to approx. 40% v/v, depending on the properties of the sludge. Next, the conditioned slurry/sludge is fed into one input of a static in-line mixer 112.

Referring to the dewatering unit 108, as stated previously, this system allows the removal of excess water from the sludge, thereby concentrating the sludge. The process is referred to as the AtmoTrans system. A separate filter system (i.e. ‘Dynasep’ system), and vortex arrangements can also be employed as necessary to provide filtration of finer slow settling particles (see the abovementioned UK patent applications).

For the dewatering unit 108, the selection and sizing of the equipment, vessels, pipework and valves is dependant on the characteristics of the sludge being recovered for encapsulation. The overall process is able to handle waste streams with a wide range of characteristics, concentrations, particle size and make-up. As the dewatering principles are determined and known, this means that for a specific application the system will be tailored to match the sludge feed stream.

The various embodiments minimize the equipment within the cell (box), thus reducing radioactive/contamination area maintenance requirements and increasing availability and reliability. A key feature of the use of dewatering technology is, again, that minimal equipment is located within the cell.

Additionally, large elements of the plant(s) may be fabricated off site, minimizing the site installation activities, with the consequential reduction in worker radiation dose uptake during construction.

The plant and process may be configured to allow for a variety of different sludge waste streams. Both the dewatering plant and the in-line mixers parameters can be changed to allow this high degree of versatility. The dewatering technology uses techniques that re-uses water to transfer sludges, and hence minimizes the consumption and potential contamination of clean water.

The various embodiments also allow the use of a ‘disposable’ in-line mixer (i.e. the mixer is built into the box and remains in the box, encapsulated) that simplifies the cleaning requirements for the process and eliminates the generation of secondary contaminated wash water waste

The various embodiment also may fill a ‘square’ box, as opposed to the existing in-drum mixing technologies; this allows much greater storage volumes to be achieved—a 25% volume utilization increase compared to a ‘large drum’ lost paddle in-drum mixing system and a 60% increase compared with a drum stillage containing 4 in-drum mixed drums. Also, in addition a wide range of boxes, waste drums, smaller containers and larger containers can also be used and benefit from this technology.

The process can be integrated with the encapsulation of solid materials. The solid waste would be located in the box prior to encapsulation, the mixed sludge/encapsulation matrix is then added using the in-line mixing technology, thus encapsulating the solids in a sludge matrix compound. This ultimately reduces the number of boxes requiring long-term storage significantly, and cannot be provided by current in-drum mixing technologies.

It should be noted that the various embodiments are not limited to a particular form of encapsulation medium.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An apparatus for encapsulating waste material in a container for long term storage, comprising:
a first storage vessel, for holding waste material;
a second storage vessel, for holding encapsulation medium;
a static vane in-line mixer, coupled for receiving waste material, and coupled to the second storage vessel, and producing, in use, a mixture of the waste material and encapsulation medium;
wherein the inline mixer is arranged for filling the container, and wherein the inline mixer comprises a disposable component disposed inside the container mounted on an internal surface of the container.

2. The apparatus of claim 1, further comprising a dewatering unit, coupled for receiving waste material from the first vessel and outputting dewatered waste material;
wherein the inline mixer is coupled to the dewatering unit and to the second storage vessel, for receiving material therefrom and producing the mixture of the dewatered waste material and encapsulation medium.

3. The apparatus of claim 2, wherein the dewatering unit comprises a dewatering vessel and pump for providing a degree of vacuum in the dewatering vessel.

4. The apparatus of claim 2, wherein the dewatering unit is operable for concentrating the waste material such that the dewatered waste material output is at about 40% v/v.

5. The apparatus of claim 1, wherein the container comprises a main body and a separate lid member; the lid member being adapted for fixed attachment to the main body of the container, and inline mixer is provided in or on the lid member; such that when the lid member is fixedly attached to the main body of the container, the inline mixer is enclosed within the container.

6. The apparatus of claim 5, wherein the container comprises unitary component with a main body and an integrally formed or fixedly attached lid member.

7. The apparatus of claim 1, wherein the inline mixer comprises a static inline mixer, for example provided with internal vanes.

8. The apparatus of claim 1, further comprising a first pump disposed between the first vessel and one of the dewatering unit and a second pump disposed between the second vessel and the inline mixer.

9. The apparatus of claim 1, further comprising a valve upstream of each of two inlet ports of the inline mixer.

10. The apparatus of claim 1, wherein the waste material comprises at least one of sludge, liquid and semi solid material.

11. The apparatus of claim 10, wherein the waste material comprises radioactive sludge from nuclear processing plant, and the encapsulation medium comprises grout.

12. The apparatus of claim 11, wherein the encapsulation medium comprises a cement-based grout including a mixture of BFS and OPC or PFA and OPC.

13. The apparatus of claim 9, wherein the waste material comprises VOCs, and the encapsulation medium comprises polymer compound.

14. A system for encapsulating waste material for long term storage, comprising:
a first storage vessel, for holding waste material;
a second storage vessel, for holding encapsulation medium:
a static vane in-line mixer, coupled for receiving waste material, and coupled to the second storage vessel, and producing, in use, a mixture of the waste material and encapsulation medium;
wherein the inline mixer is arranged for filling the container, and wherein the inline mixer comprises a disposable component disposed inside the container mounted on an internal surface of the container.
a container, the container comprising (i) a main body and separate lid member, or (ii) a unitary component with a main body and an integrally formed or fixedly attached lid member.

15. The system of claim 14, wherein the container contains solid hazardous waste.

16. The system of claim 14, wherein the container comprises:
(i) a main body and separate lid member, or (ii) a unitary component with a main body and an integrally formed or fixedly attached lid member; the container incorporating the in-line mixer disposed therein or mounted on an internal surface there of, for example on an inner surface of the lid member.

17. A method of encapsulating waste material in a container for long term storage, the method comprising:
(a) providing a first storage vessel, for holding waste material; (b) providing a second storage vessel, for holding encapsulation medium;
(c) providing an in-line mixer, coupled for receiving waste material, and coupled to the second storage vessel,
(f) mixing the waste material and encapsulation medium in the inline mixer;
(g) filling the container with the mixture output from the inline mixer, wherein the (c) providing includes providing a container, wherein the inline mixer comprises a disposable component disposed inside the container or on mounted an internal surface of the container.

18. The method of claim 17, further comprising:
(d) providing a dewatering unit, coupled to the first vessel, and
(e) dewatering the waste material received from the first vessel and outputting dewatered waste material;
wherein the in-line mixer is coupled to the dewatering unit and to the second storage vessel, the (f) filling comprises producing a mixture of the dewatered waste material and encapsulation medium.

19. The method of claim 18, wherein the dewatering unit comprises a dewatering vessel and (e) includes using a pump to provide a degree of vacuum in the dewatering vessel.

20. The method of claim 18, wherein the (e) dewatering includes concentrating the waste material such that the dewatered waste material output is at about 40% v/v.

21. The method of claim 17, wherein the container comprises a main body and a separate lid member; and the (c) providing includes fixedly attaching the lid member to the main body of the container, and wherein inline mixer is provided in or on a lid member; such that when the lid member is fixedly attached to the main body of the container, the inline mixer is enclosed within the container.

22. The method of claim 17, wherein the container comprises unitary component with a main body and an integrally formed or fixedly attached lid member.

23. The method of claim 17, wherein the inline mixer comprises a static inline mixer with internal vanes.

24. The method of claim 18, further comprising:
(h) pumping with a first pump the material output from the first vessel to the dewatering unit; and/or
(i) pumping with a second pump the material output from the second vessel to the inline mixer.

25. The method of claim 24, further including:
(j) controlling the flow of material to the inline mixer using a valve upstream of each of two inlet ports of the inline mixer.

26. The method of claim 25, wherein the waste material comprises one of sludge, liquid and semi solid material.

27. The method of claim 26, wherein the waste material comprises radioactive sludge from nuclear processing plant, and the encapsulation medium comprises grout.

28. The method of claim 27, wherein the encapsulation medium comprises a cement-based grout including comprising a mixture of BFS and OPC or PFA and OPC

29. The method of claim 26, wherein the waste material comprises VOCs, and the encapsulation medium comprises polymer compound.

30. The method of claim 17, further comprising preloading the container with solid hazardous waste.

31. (canceled)
